(19) United States
(12) Patent Application Publication
(10) Pub. No.: US 2006/0069682 A1
(43) Pub. Date: Mar. 30, 2006

(54) Profiler tool for database servers

(75) Inventors: Karim A. Fanous, (US); Gabriel Ghizila, (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/944,252

(22) Filed: Sep. 16, 2004

(51) Int. Cl. G06F 7/00

(52) U.S. Cl. 707/8

(57) ABSTRACT

A system and method for profiling a database server comprising a parser for parsing stored procedure events data and a call stack tree for receiving stored procedure events data. The profiling of the stored procedure events data enables a user to determine a relationship between stored procedures within a stack of stored procedures, and to build views of the events data to quickly determine causes of latency within a database server.

### FIELD OF THE INVENTION

The field of the invention generally relates to profilers of software applications and specifically to profilers of database servers.

### BACKGROUND OF THE INVENTION

A client computer may run an application such as a server application that may use a database server to store data about the client. The client may call on the database server to retrieve stored data in various forms. The database server may manipulate the data and provide the results of the manipulation back to the caller. The database server may serve numerous clients or applications.

The database server also may include rooted or embedded functions or programs called stored procedures to execute and manipulate data. FIG. 1 depicts a block diagram showing an example relationship between stored procedures. As depicted in FIG. 1, stored procedures may be layered or stacked within the database server such that they may call other stored procedures. The other stored procedures may then execute and send results back to the calling stored procedure. For example, when a first stored procedure 10 is executed, it may require data to be manipulated by a second stored procedure 20, which in turn may require data to be manipulated by a third and a fourth stored procedure 30, 40. The first stored procedure 10 may not complete its execution until it receives data from the second stored procedure 20. The second stored procedure 20 may not complete its execution until it receives data from the third and fourth stored procedures 30, 40. The first stored procedure 10 may be considered a parent of the second stored procedure 20, and, likewise, the second stored procedure may be considered a child of the first store procedure 10. The second stored procedure 20 may be considered a parent of children stored procedures 30, 40. The first, second, third, and fourth stored procedures 10, 20, 30, 40 may be considered “stacked” in that the execution of one of the stored procedures may be called for or instigated by another stored procedure.

The amount of time required for a stored procedure to execute may be of interest to the application calling the stored procedure or to the user. Typically, the client application requesting the execution of the stored procedure is suspended pending the outcome of the execution. The database server should provide results of an execution of a stored procedure as quickly as possible. The database server, therefore, is required or expected to execute its stored procedures as quickly as possible.

When the response from the database server is slow, the user may want to know the cause of the sluggishness or latency. More specifically, the user may want to know which stored procedures are executed sluggishly so that problems may be targeted, addressed, and rectified. The user may also want to know the cause of latency within a stored procedure. The latency within a stored procedure may be caused, for example, by a stored procedure calling a data store, table, column of a table, etc., that has been “locked.” This means that another caller, such as another stored procedure or client application, may be using the data store or table and therefore the data store may be “locked” to all other callers. The execution of a stored procedure may be delayed until the data store or table is unlocked.

To determine the cause or causes of latency problems, a database server application may provide a profiler. A profiler may be a program that tracks the performance of another program. The profiler may be rooted or embedded in the database server and may be capable of providing a snapshot of activity in the database server. It may provide the user with data such as stored procedures that have been executed over a specified time period. The profiler additionally may allow the user to sort the data. The data may be sorted, for example, by execution time, showing which stored procedures took the longest time to execute.

A problem that may be associated with profilers of database servers, however, is that the information the profilers provide may not provide useful information regarding stacked stored procedures. More specifically, the profiler may not show the parent-child relationship between stored procedures, which may obscure the true cause of latency within the stack. For example, referring again to FIG. 1, we may assume that the inclusive execution times for the stored procedures 10, 20, 30, and 40 are, respectively, 90 μsec, 80 μsec, 60 μsec, and 10 μsec. For the purposes of the example, we may assume that each stored procedure should have an extrinsic execution time of about 10 μsec.

A database server profile may properly reflect the intrinsic execution times. However, contrary to profilers used in other operating environments, a database server profile may not provide the relationship between the stored procedures 10, 20, 30, 40. That is, the database server profiler may not show that the first stored procedure 10 is a parent of the second stored procedure 20 and a “grandparent” of the third and fourth stored procedures 30, 40. The profiler also may not provide the extrinsic execution times for each stored procedure. Therefore, the database server profiler may lead the user to suspect that latency problems exist in the first stored procedure 10 because it took 90 μsec to execute. The user may also believe that a latency problem is associated with the second stored procedure 20, which took 80 μsecs to execute, and the third stored procedure 30, which executed in 60 μsec. Because the database server profiler does not show the stacked relationship between the stored procedures, the user does not know that 80 μsec of the execution time of the first stored procedure 10 was spent waiting for the second stored procedure 20 to execute. The user also may not know that the second stored procedure 20 spent 60 μsec waiting for the third stored procedure 30 to complete execution. In short, because the database server profiler does not show the stacking relationship between the stored procedures, a user may not be quickly directed to the third store procedure 30 as the source of a latency problem within the first stored procedure 10.

Additionally, the database server profiler may not provide information regarding the problem causing the latency within a stored procedure. For example, if the latency within the third stored procedure 30 is caused by a lock on a data store that the third stored procedure calls, the database server profiler may not provide this information to the user. The user therefore may check all possible causes for the latency before determining that it is caused by a locked data store.

Therefore, in a database server, there is a need to be able to determine the cause of latency problems within stacks of stored procedures and also within individual stored procedures.

### SUMMARY OF THE INVENTION

The invention may optimize throughput and minimize latency in a database server environment by providing a system and method for profiling stacked stored procedures. The invention may enable a user to quickly determine intrinsic and extrinsic execution durations for stored procedures. The invention may enable a user to determine the relationship between stored procedures in a stack. The invention may also enable the user to determine the cause of a latency problem in the execution of a stored procedure. In this way, the invention may help identify potential bottlenecks or high execution times with a stack of stored procedures.

Events such as a stored procedure starting event, stored procedure completed event, remote procedure call starting event, or remote procedure call completed event may be registered. Such events may be registered on an events table or an events file. A parser may parse the events and build a call stack tree for each event. In doing so, the interrelationship between stored procedures within a stack of stored procedures may be recorded. The call stack tree may then be merged into a global list of call stacks in such a way that common call stacks may be viewed and meaningful information provided. Such information may enable a user to pinpoint a sluggish stored procedure that was called by another stored procedure. Such information may also enable a user to pinpoint an object that causes latency because, for example, it is locked during execution of stored procedures.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings example constructions of the invention; however, the invention is not limited to the specific methods and instrumentalities disclosed. In the drawings:

FIG. 1 is a block diagram showing an example relationship between stacked stored procedures in a database server;

FIG. 2 is a block diagram showing an example computing environment in which aspects of profiling a database server system may be implemented;

FIG. 3 is a block diagram depicting an example embodiment of an events table on a database server;

FIG. 4 is block diagram depicting an example embodiment of a database server profiler;

FIG. 5A-5B are block diagrams depicting example views that may be provided by a database server profile; and

FIG. 6 is a flow chart depicting an example method for profiling a database server.

### DETAILED DESCRIPTION OF ILLUSTRATIVE EMBODIMENTS

Example Computing Environment

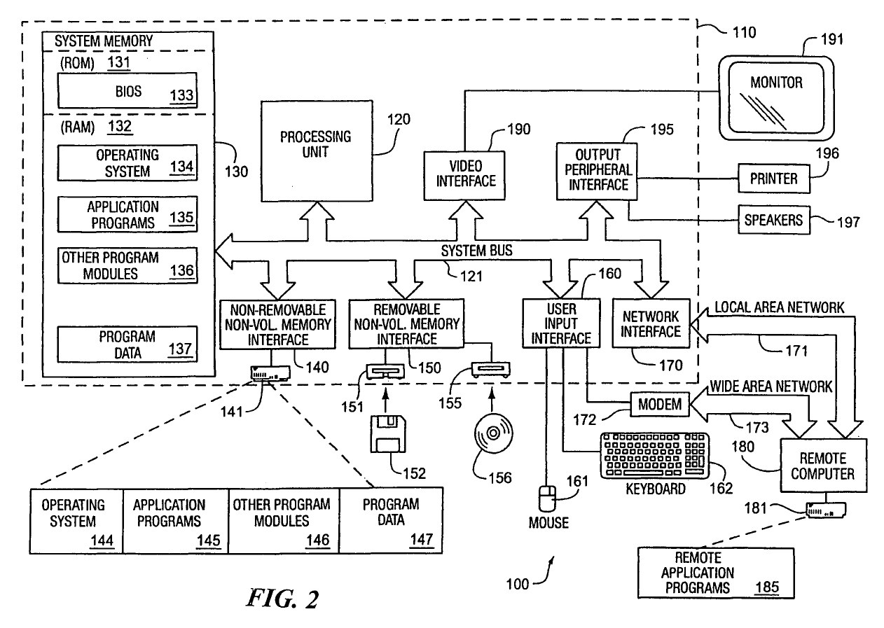

FIG. 2 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 2 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 2, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2 provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Profiling Tool for Database Servers

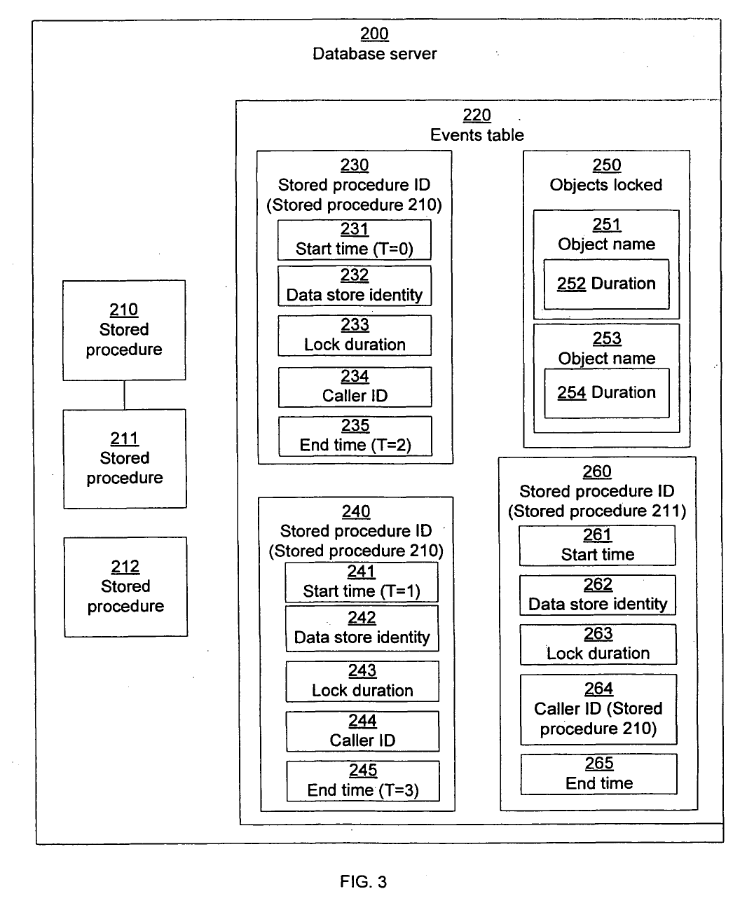

FIG. 3 depicts a block diagram of an example embodiment of an events table 220 and stored procedures 210-212 of a database server 200. A database server such as the database server 200 may reside on a computer 110 as described with regard to FIG. 2. The database server 200 may have any number of tables similar to the events table 220 and any number of stored procedures 210-212. A database server such as the database server 200 may additionally contain other components not shown in FIG. 3, such as databases, data structures, data stores, tables, profilers, parsers, etc.

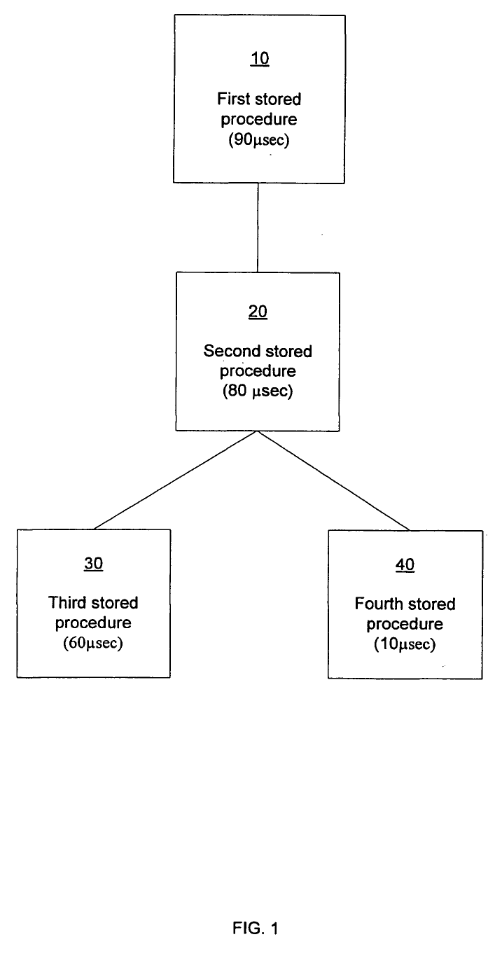

The database server 200 may include the stored procedures 210-212, each of which may, for example, execute a function independently of the others. Alternatively, the stored procedure 210, for example, may be a parent stored procedure as described with regard to FIG. 1. That is, the stored procedure 210 may be a parent of the stored procedure 211 or a parent of both the stored procedures 211, 212. The stored procedure 212 may be, for example, a parent of the stored procedure 211. In the example embodiment shown in FIG. 3, the stored procedure 210 is a parent of the stored procedure 211. As explained earlier, this means that when the stored procedure 210 is executed, it calls for the execution of the stored procedure 211. Upon completion of its execution, the stored procedure 211 will send appropriate data to the stored procedure 210 so that the stored procedure 210 can complete its execution.

The stored procedures 210-212 each may be a program or function physically embedded or rooted within the database server 200. Each of the stored procedures 210-212 may have a name and parameters. The stored procedure 210, for example, may be used to validate data integrated into a database structure. The stored procedure 211, for example, may encapsulate a complex process such as manipulating a large data structure to produce a summarized result. The stored procedures 210-212 may be programmed to perform any function required of the database server 200 or clients or applications (not shown) calling the database server 200.

An advantage of placing such programs or functions within the stored procedures 210-212 rooted in the database server 200 is that such rooting may allow for the execution of a program or function without requiring a query to a separate database system for data. The rooting of stored procedures 210-212 in the database server 200 may reduce the need for communicating large amounts of data back and forth between a client or application (not shown) and the database server 200 in order to execute a program or function rooted in the client. The function and the data necessary to complete the function may be colocated on the database server 200.

Another advantage of rooting the stored procedures 210-212 in the database server 200 is that it may enable many clients or applications to access the program or function of each of the stored procedures 210-212, reducing the need to embed the program or function in each of the client applications. This embedding simplifies application development and maintenance because the database server 200 becomes the sole host of the function or program. Stored procedures 210-212 also may provide consistent implementation of business logic to clients written in different languages and running in different environments.

As noted, the stored procedures 210-212 may be executed at the instigation of a client computer or application (not shown). Such instigation may be completed by a remote procedure call. A remote procedure call may be a protocol that allows an application running on a client to call the database server 200, for example, and provide arguments for use in the execution of one or more of the database server's stored procedures 210-212. During the time of execution of the stored procedures 210-212, the application running on the client may be suspended until a result is returned from the database server 200. Upon completion of the execution of the stored procedures 210-212, the result is communicated back to the client or application that sent the initial remote procedure call. Events data regarding remote procedure calls may also be recorded on an events table and accordingly profiled similar to stored procedures.

Upon execution of a stored procedure such as the stored procedure 210, information may be recorded by the database server 200. This information may be recorded in the events table 220 created by the database server or a profiling tool. Alternatively, the information may be recorded in an events file (not shown) that may be created by the database server or a profiling tool. A user may select whether the information is recorded in the events table 220 or the events file. The information recorded in the events table 220 or in an events file may be recorded chronologically and may be retained for any amount of time. The information may include a stored procedure identification 230 comprising the name of the stored procedure being executed (namely, in the example embodiment depicted in FIG. 3, the stored procedure 210). Additionally, the recorded information may include a start time of the execution 231 of the stored procedure 210. This time may be in any appropriate format. The events table 220 shows the stored procedure 210 being executed at a time equal to 0 (T=0). It should be noted that the times used throughout this specification are for example purposes only and may not reflect an actual format for recording times.

The recorded information may include a lock duration 233 that may indicate a duration of time that a locked object was encountered by the stored procedure 210 during execution. Such objects may include a data store, a table, rows or columns in a table, etc. When objects within a database are accessed for reading from them, writing to them, etc., the object may acquire a lock. The locking of objects may prevent access by other callers. Other callers may be other stored procedures that other clients or applications have instigated or that parent stored procedures have instigated. When a caller is pulling or updating data from a table, for example, other callers may not be able to access the table until the previous data call is completed. An object that is locked often or for a long duration may be a contention point, causing latency in the execution of one or more stored procedures. A user may want to know which objects are locked and determine the cause. Therefore, in addition to registering the lock duration 233 encountered by the stored procedure 210, locked objects 250 may also be registered to the events table. Such registration may include each locked object's name 251, 253 and the duration 252, 254 that the each object was locked.

The recorded information in the events table 220 (or an events file) for the stored procedure identification 230 may also include a data store identity 232. The data store identity 232 may include a name of any data stores called during the execution of the stored procedure 210. Information recorded on the events table 200 may include a caller identification 234 indicating the name of the client, application, or other stored procedure requesting execution of the stored procedure 210. The caller identification label—such as a distinct number—may be provided by the database server 200. The recorded information may additionally include the end time 235 indicating the time that the execution of the stored procedure 210 was completed. The events table 220 shows the end time 235 of the execution of the stored procedure 210 to be a time equal to 2 (T=2) (e.g., 2 seconds or 2 milliseconds after the start of the execution).

The events table 220 may contain similar data for an execution of the stored procedure 210 at a different time such as at a time equal to 1 (T=1). As explained above, the events data may include: a stored procedure identification 240; a start time 241 of the execution; a data store identification 242 of any objects called during the execution; a lock duration 243 indicating the duration of time that a locked object was encountered by the stored procedure during execution; a caller identification 244 indicating the name or identity of the client or application requesting execution of the stored procedure; and an end time 245 showing the time that the execution of the stored procedure 210 was completed. The completion of the execution of the stored procedure 210 in the stored procedure identification 240 register was at a time equal to 3 (T=3).

As shown for example in the events table 220, the execution of the stored procedure 210 at the time T=0 for the caller identified by the caller identification 234 ended at a time T=2. The execution of the stored procedure 210 for the caller identified by the caller identification 244 started at a time T=1. The second execution (T=1) of the stored procedure 210 started at T=1, before the completion of the first execution of the stored procedure 210 at the time T=2. The stored procedure 210 may be executed for clients or callers before previous executions have been completed. In determining the duration of an execution of the stored procedure 210, it may be useful or necessary to link the stored procedure identification 230 with the start time 231, any databases called 232, the identification of the client calling for the execution 234, the end time of the execution 234, etc. In this way, the data later may be linked together, showing, for example, which recorded end time for an execution of a stored procedure “belongs” to which recorded start time.

During its execution, the stored procedure 210 may call for the execution of a stored procedure 211. That is, the stored procedure 210 may be a parent of the stored procedure 211. Data similar to the data recorded for the execution of the stored procedure 210 may be recorded for the stored procedure 211 as a stored procedure identification 260. The stored procedure identification 260 may include: a start time 261; an end time 265; a data store identity 262 if any data stores are accessed; a lock duration 263 if any objects are locked during the execution; and a caller identification 264. The caller identification 264 information may reflect the caller as stored procedure 210. In this way, data about a stored procedure executed within a stack of stored procedures will be retained and may be viewed later by a user.

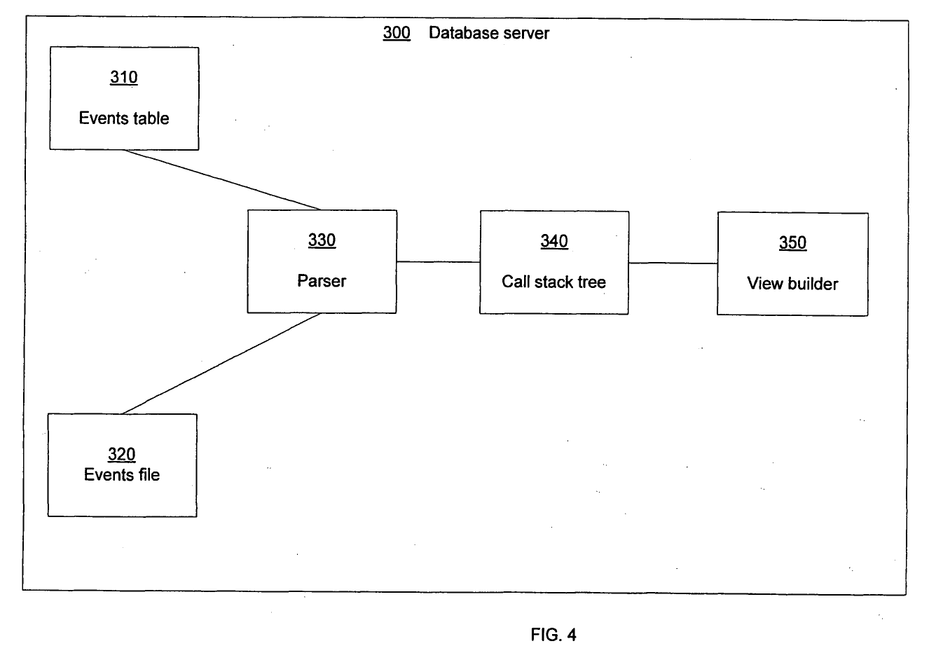

FIG. 4 depicts a block diagram of an example embodiment of a system for profiling stacked stored procedures with a database server 300. The database server 300 may reside on the computer 100 as described with regard to FIG. 2. The database server 300 may be the same as the database server 200 described with regard to FIG. 3. The profiling system may include an events table 310 and/or an events file 320, a parser 330, a call stack tree 340, and a view builder 350.

The events table 310 and/or the events file 320 may contain registered events data as described with regard to FIG. 3. This data may either be sent to or pulled by the parser 330. The parser 330 may separate and organize the events data, keeping track of the interrelationship between the data (e.g., the execution times of stored procedures, the interrelationship between parent and child stored procedures, any locks on data stores that impeded the execution of a stored procedure, etc.) The parser 330 may parse the events data and aggregate the data into unique call stacks and send the data to the call stack tree 340. Similar data may be grouped together. For example, the starting time of all of the executions of each stored procedure or remote procedure call may be grouped together. The ending time of all of the executions of each stored procedure and remote procedure call may be grouped together. Any objects that may have been lock acquired during the execution of stored procedures may be grouped together. It should be noted that the groupings listed here are for example purposes and it should be understood that other grouping may occur.

After the call stack tree has been created, the data may be sorted. The user may read or view the data contained on the call stack tree 340 through the view builder 350. In this way, a user, developer, tester, etc., may determine the duration of the execution of each stored procedure, the number of times each stored procedure was executed over a given amount of time, the duration and number of objects that were lock acquired, the interrelationship between parent and child stored procedures, etc. The view builder 350 may present the information in a format so that the user can view and quickly determine any areas requiring attention.

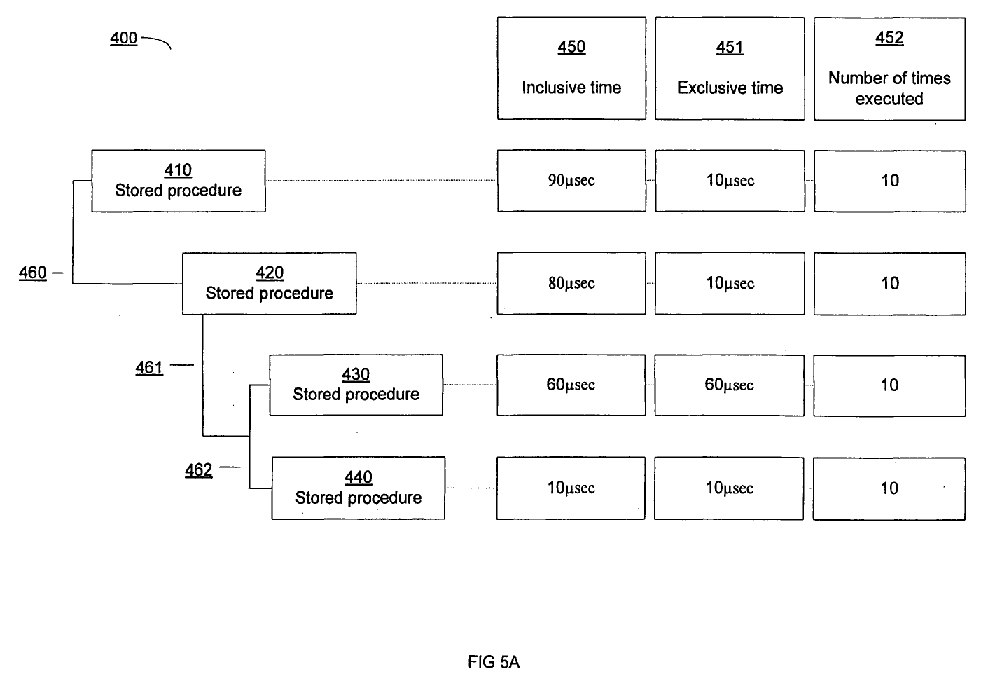

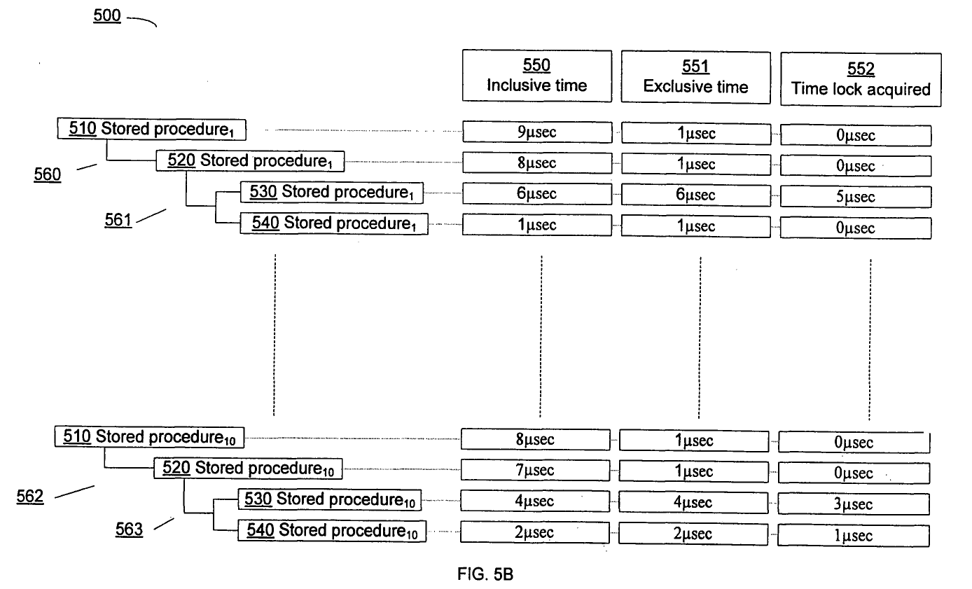

FIGS. 5A-5B show block diagrams depicting example views that the view builder 350 may create for review by a user. The view builder may present the data in any manner in which the user may desire. FIGS. 5A-5B provide only two examples of numerous ways the data may be viewed. Those skilled in the art will recognize that other views may be created and that other data may be included in the views.

FIG. 5A presents a block diagram of an aggregate view 400 of data collected by a profiler in accordance with one example embodiment of the invention. The aggregate view 400 may provide a column 452 showing the number of times each stored procedure was executed during the profiling period. In the example aggregate view 400, the stored procedures 410, 420, 430, 440 were each executed 10 times. Of course, stored procedures may be executed any number of times over a given period and may be executed a different number of times than each other.

The aggregate view 400 may also show an inclusive time 450 and an exclusive time 451 of the execution of the stored procedures 410, 420, 430, 440. The inclusive time may reflect the amount of time that a stored procedure spent completing its execution. The inclusive time may include the execution times for child stored procedures that the parent stored procedure called during its execution. The exclusive time, on the other hand, may reflect the amount of time that a stored procedure spent executing its function or code and may not include the time that the stored procedure was waiting for one or more child stored procedures to execute.

In the example aggregate view 400, the inclusive time for stored procedure 410 is 90 μsec, which includes an 80 μsec execution time for stored procedure 420. The extrinsic time for stored procedure 410 is 10 μsec, showing that it took 10 μsec for stored procedure 410 to execute its function or code. Similar data is shown for the stored procedures 420, 430, 440.

The aggregate view 400 may also show the interrelationship between the stored procedures 410, 420, 430, 440. The interrelationship may be shown through a tree depiction, as in FIG. 5A. A line 460 shows the stored procedure 410 as a parent of the stored procedure 420. The lines 461, 462 shows the stored procedure 420 as a parent of both the stored procedures 430, 440. It should be recognized that other methods may be used to show the interrelationship of stored procedures in a stack of store procedures. Additionally, it should be recognized that other data may be shown in the aggregate view (e.g., duration of time the stored procedure was locked from access to a table or data store).

FIG. 5B shows an alternative view, an individual execution view 500. The view builder 350 may provide an individual execution view 500, showing data about one or more executions of one or more stored procedures 510₁₋₁₀-540₁₋₁₀. The individual execution view 500 may show inclusive time 550 and exclusive time 551 for each execution of a stored procedure. For example, FIG. 5B shows that for the first execution of a stored procedure 510₁, the inclusive time was 9 μsec and the exclusive time was 1 μsec. For the tenth execution of the stored procedure 510₁₀, the inclusive time was 8 μsec and the exclusive time was 1 μsec. The execution view 500 may show any number of executions. 10 executions are shown merely for example purposes.

An individual execution view 500 may additionally show the amount of time that each stored procedure was lock acquired and waiting for an object to unlock. A time lock acquired 552 column may show, for example, that in the first run of a stored procedure 530₁, the execution was delayed 5 μsec because of a lock on an object. The time lock acquired 552 column shows that, in the tenth run of the same stored procedure (the stored procedure 530₁₀), the delay caused by a locked object was 3 μsec.

The individual execution view 500 may also show the interrelationship of stored procedures within a stack of stored procedures. This may be shown by “tree” lines 560-563 or in any other appropriate manner.

Other views may also be available if appropriate data is recorded in the events table 220 or in an events file. For example, a view may show the number of times a table or other object was locked over the profiling period. A view may show the total amount of time that a table or other object was locked. Additionally, a view may show how many new files were opened during the profiling period or how many stored procedures called a specific stored procedure. The potential views listed above are examples, and those skilled in the art will recognize that a view may be created for any data registered in the events table 310 or events file 320.

Additionally, the data shown in any view developed by the view builder 350 may be sorted. The aggregate view may be sorted, for example, by the number of stored procedures that were executed. The view may be sorted by the inclusive or exclusive time for each execution of the stored procedures. Those skilled in the art will recognize that the data may be sorted in other ways as well.

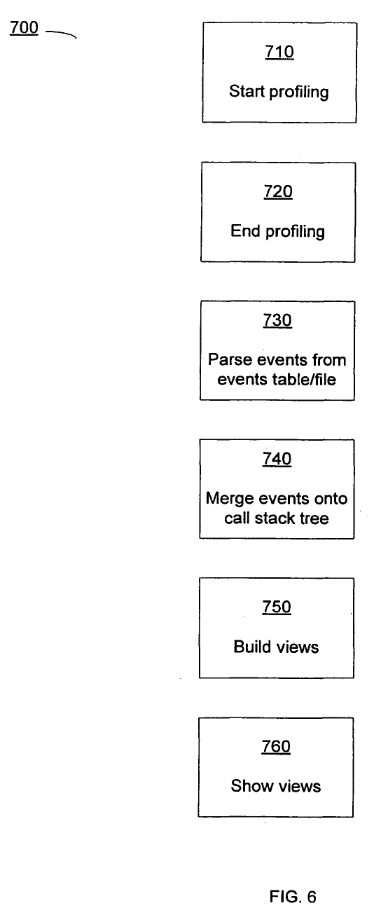

FIG. 6 depicts a flow diagram of a method for profiling a database server in accordance with an alternative example embodiment of the invention. At step 710, the profiler may begin profiling or registering events data on the events table 310 or the events file 320. At step 720, the recording of the information may stop. A user may manually stop the profiling or a preset time period may expire, causing the profiling to stop. At step 730, the parser 330 may parse the information contained in the register. The parser may group similar information together. For example, the parser may group the starting events for each stored procedure together. The parser may then merge the events onto the call stack tree 340 at step 740. At step 750, the view builder 350 may build the views either automatically or at a user's request. Finally at step 760 the views may be displayed to the user.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other embodiments may be used or modifications and additions may be made to the described embodiments for performing the same function of the present invention without deviating therefrom. Throughout the specification, examples were provided for data that may be registered on an events table or file and that may be parsed for viewing. The examples of the types of data that may be profiled by the invention are for example purposes only. Any appropriate data may be profiled in accordance with embodiments of the invention. Additionally, the data that is profiled may be viewed in any appropriate manner. The example views described herein were provided to enhance understanding. Any appropriate views, however, may be used in accordance with embodiments of the invention and such views may depend on the needs of the user. In no way is the present invention limited to the examples provided herein. Therefore, the present invention should not be limited to any single embodiment, but rather should be construed in breadth and scope in accordance with the appended claims.

What is claimed:

1. A system for profiling a database server, comprising:
a parser for parsing stored procedure events data; and
a call stack tree for receiving stored procedure events data, wherein the stored procedure events data comprises:
an identity of a first stored procedure,
an identity of a second stored procedure executed at the instigation of the first stored procedure, and
data showing that the first stored procedure instigated the execution of the second stored procedure.

2. The system of claim 1, further comprising:
a register comprising stored procedure events data in the form of at least one of an events table and an events file.

3. The system of claim 2, wherein the stored procedure events data comprises at least one of a start time, an end time, a data store identity, a lock duration, a caller identification, a locked object name, an inclusive execution duration, an exclusive execution duration, a locked object identity, and a locked object duration.

4. The system of claim 1, further comprising
a view builder for presenting a view of the stored procedure events data.

5. The system of claim 4, wherein the view builder creates at least one of an aggregate view and an individual execution view of the stored procedure events data.

6. The system of claim 4, wherein the stored procedure events data can be selectively sorted.

7. The system of claim 4, wherein the view of the stored procedure events data comprises at least one of inclusive execution duration data, exclusive execution duration data, total number of executions data, data showing relationships between stored procedures within a stored procedure stack, and lock duration data for any objects locked during executions of stored procedures.

8. A method for profiling a database server, comprising:
registering stored procedure events data;
parsing the stored procedure events data; and
merging the stored procedure events data, wherein the stored procedure events data comprises data showing relationships between a plurality of stored procedures within a stack of stored procedures.

9. The method of claim 8, further comprising:
building a view of the merged stored procedure events data.

10. The method of claim 9, wherein the view comprises at least one of an aggregate view of the merged events data, an individual execution view of the merged events data, a view of an identity of a locked object, and a view of a duration that an object was locked.

11. A computer-readable medium having computer-executable instructions for performing steps, comprising:
parsing stored procedure events data; and
merging the stored procedure events data, wherein the stored procedure events data comprises data showing a relationship between a plurality of stored procedures within a stack of stored procedures.

12. The computer-readable medium of claim 11, having further computer-executable instructions for performing the step of:
registering stored procedure events data.

13. The computer-readable medium of claim 11, having further computer-executable instructions for performing the step of:
building a view of the merged stored procedure events data.

14. A computer-readable medium having stored thereon a data structure, comprising:
a first data field comprising data representing an identification of a first stored procedure;
a second data field comprising data representing an identification of a second stored procedure; and
a third data field comprising data representing that the first stored procedure instigated the execution of the second stored procedure.

15. The computer-readable medium of claim 14, further comprising:
a fourth data field representing an identification of a locked object that delayed the execution of at least one of the first and second stored procedures.

16. The computer-readable medium of claim 14, further comprising:
at least one data field comprising at least one of:
inclusive execution duration data,
exclusive execution duration data,
total number of executions data,
data showing relationships between stored procedures within a stored procedure stack, and
lock duration data for any objects locked during execution of a stored procedure.
